(19) United States
(12) Patent Application Publication
(10) Pub. No.: US 2004/0006847 A1
(43) Pub. Date: Jan. 15, 2004

(54) Face frame snap-on hinge

(76) Inventors: Joseph B. Larsen JR., Kernersville, NC (US); Kerry L. Kerr, Kernersville, NC (US)

Correspondence Address: Charles Y. Lackey, PO Box 5871, Winston-Salem, NC, 27113-5871, US

(21) Appl. No.: 10/615,654

(22) Filed: Jul. 10, 2003

Related U.S. Application Data
(63) Continuation of application No. 10/159,733, filed on Jun. 3, 2002.

(51) Int. Cl. E05D 7/10

(52) U.S. Cl. 16/257

(57) ABSTRACT

A face frame snap-on hinge for adjustably supporting a door on an associated frame utilizes a hinge cup inserted within a bore provided in the interior side of the door. A hinge pin is mounted inside the hinge cup and pivotally connects with one end of a hinge arm. The other end of the hinge arm forms a connecting and release mechanism for the door. A base plate is adjustably connected to preferably the frame and an adjusting member is fastened to the base plate. A cam screw is associated with the adjusting member and the base plate to permit the adjustment of the door with the frame while the hinge arm and base plate remain connected. The door and frame can be adjusted by two independent procedures, both of which permit adjustment to be made without separating the door from the frame.

This application is a continuation of my pending application Ser. No. 10/159,733 entitled Face Frame Snap-On Hinge.

### BACKGROUND OF THE INVENTION

1. Field of the Invention

The present invention relates to a hinge for mounting a door on the frame of a cabinet or an article of furniture and more particularly to a snap-on adjustable hinge adapted to provide the adjustment of a mounted door relative to the associated door supporting frame in different ways.

2. Description of the Prior Art

Numerous hinges for mounting doors on cabinets and furniture articles [which] have been used in the cabinet and furniture industry for quite some time. Note, for example, U.S. Pat. No. 5,621,947 describing a hinge arm riveted to a mounting plate in an undetachable and fixed configuration which limits the range of adjustments that can be made to align mounted doors with respect to their supporting frames.

See also U.S. Pat. No. 5,920,958 for a more recent hinge development of a hinge having a single adjustment screw which can be reached at either of its slotted ends for the necessary adjustment between door and frame.

Other drawer supporting hinges have been [available] in use for some time, many of which require the loosening of screws and the manual repositioning of the door with respect to the frame before the loosened hinge is thereafter re-tightened to finalize alignment. Certain characteristic of these type hinges are desirable in that they are strong, durable and quite cleverly concealed within the configuration of the cabinet or the furniture article, however there is a continuing desire to provide such hinges with greater efficiency, more precise reliability, and a simple single step adjustment. It is to these refined features that the present invention is directed.

### SUMMARY AND OBJECTIVES OF THE INVENTION

The hinge of the present invention includes a face frame snap-on hinge for adjustably supporting a door on an associated supporting frame, the door member preferably having a circular bore with a hinge cup inserted in the bore. A hinge pin is mounted in the hinge cup, and a hinge arm has one end pivotally secured to the hinge pin and the other hinge end forming a hinge arm connecting and release mechanism. A base plate is releasably secured to the frame member, and a door adjustment member is moveably secured to the base plate. A camming member is associated with the door adjustment member and the base plate to selectively position the door adjustment member with the base plate to provide for selective positioning of the door member with respect to the frame member while the hinge arm second end and the base plate remain connected.

The hinge arm connecting and release means is independently adjustable to selectively position the frame member with respect to the door member and can also be operated to disconnect the hinge arm from the hinge plate. The door adjustment member has a camming member to operably control the selective positioning of the door member with respect to the frame member.

The hinge arm connecting and release mechanism is a flexible U-shaped member having gripping elements to releasably engage and secure the door adjustment member and a moveable tab to disengage the gripping elements from the door adjustment member. The hinge arm and the hinge arm connecting and release mechanism have aligned openings permitting independent adjustment of the door adjustment member therethrough.

The hinge arm has an opening through which extends a threaded member and the hinge arm flexible U-shaped member has a threaded aperture substantially aligned with the hinge arm opening and operably receiving the threaded member. The threaded member is operable to tighten the U-shaped member with respect to the hinge arm and loosen the U-shaped member with respect to the hinge arm to permit adjustment of the door with respect to the frame member.

From the foregoing summary, it is apparent that an objective of the present invention is to provide a new and improved snap-on hinge for mounting a door on a frame of a cabinet or an article of furniture which has all of the advantages, or more, of prior air devices and none of the disadvantages.

It is another objective of the present invention to provide an improved snap-on hinge for mounting a door on a frame that is more reliable and functional and more readily adjustable than many of the hinges presently available.

Yet another objective of the present invention is to provide a new snap-on adjustable hinge that can be adjusted in two independent ways to enable the greatest amount of adjustability.

Yet still another further objective of the present invention is to provide an adjustable snap-on hinge of the type described that is easily accessible for adjustment within the interior of the cabinet or furniture article to which it is attached without separating the base from the hinge arm.

The summary and objectives above focus on the more important features of the invention in order that the detailed description which follows may be better understood and that the present contribution to the art may be better appreciated. There are, of course, additional features of the invention that will be described hereinafter that will form the subject matter of the claims appended hereto. It is to be understood that the invention is not limited in its application to the details of construction and to the arrangement of the components set forth in the following description and illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized for designing other structures, methods and systems for carrying out the several purposes of the invention. It is also to be understood that the abstract is neither intended to define the invention of the application, which is measure by its claims, nor to limit its scope in any way.

This summary and these objectives of the invention, along with the various features of novelty which characterize the invention, are pointed out with with particularity in the claims annexed to and forming a part of this disclosure. For a better understanding of the invention, its operating advantages and the specific objects obtained by its use, reference should be made to the following detailed specification taken in conjunction with the accompanying drawings wherein like characters of reference designate like parts throughout the several views.

### BRIEF DESCRIPTION OF THE DRAWINGS

FIG. 1 is a top plan view of the snap-on hinge comprising the present invention showing the door and supporting frame in the closed position;

FIG. 1a is a top plan view of the snap-on hinge shown in FIG. 1 facing in the opposite direction;

FIG. 1b is a top plan and sectional view of the snap-on hinge shown in FIG. 1a;

FIG. 2 is a side elevational view of the hinge of the present invention showing the door in the closed condition

FIG. 2a is a side elevational view of the hinge of the present invention shown in FIG. 2 having a slightly different base plate design;

FIG. 3 is a side elevational view of the hinge of the present invention with the door in the open condition;

FIG. 3a is a side elevational view of the hinge shown in FIG. 3 wherein the base plate has the design of the base plate shown in FIG. 2a;

FIG. 4 is a side elevational view of the hinge of the present invention with the door and frame in the unconnected condition;

FIG. 5 is top plan view of the hinge of the present invention with the door and frame in the unconnected condition and the hinge disassembled into its separate components;

FIG. 6 is a top plan view of the hinge arm in its disassembled condition;

FIG. 7 is a top plan view of the base plate secured to the frame;

FIG. 7a is a side elevational and enlarged and isolated view of the cam on the free end of the base plate and the cam portion of the U-shaped member;

FIG. 8 is a top plan view of the U-shaped member disconnected from the hinge showing the cam portion;

FIG. 9 is a top plan view of the hinge of the present invention showing the door and connected frame in the door open position;

FIG. 9a is a top plan view of the hinge of the present invention on the opposite and adjacent door and connected frame in the door open position;

FIG. 9b is a top plan and sectional view of the hinge, door and connected frame shown in FIG. 9a; and

FIG. 10 is a perspective and exploded view of the hinge, door and frame of the present invention.

### DETAILED DESCRIPTION OF PREFERRED EMBODIMENT

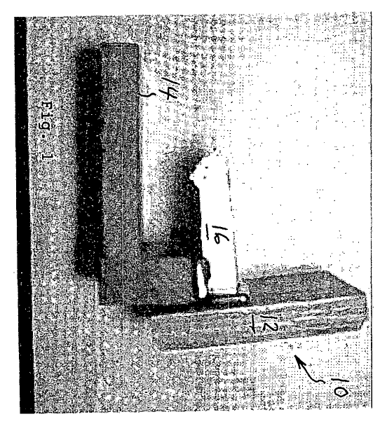

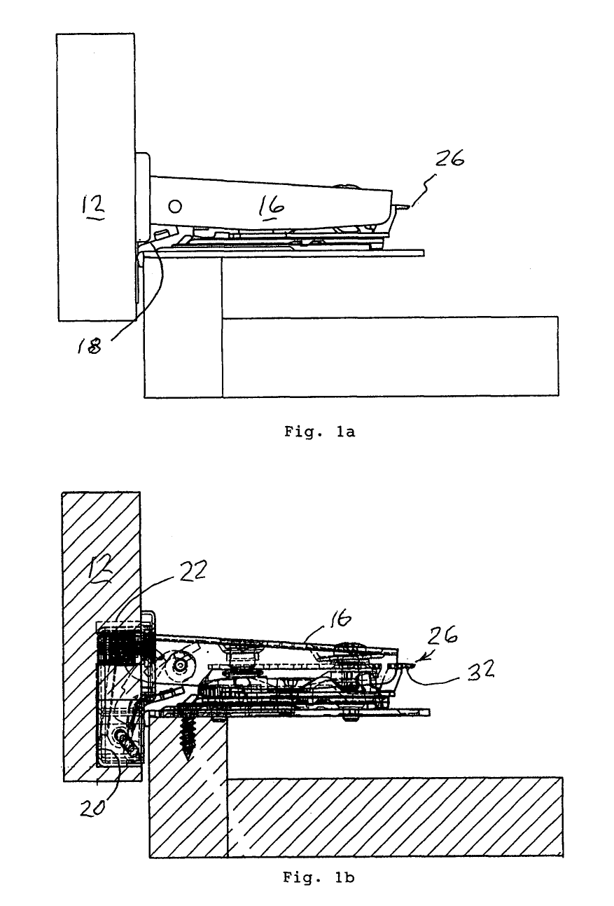

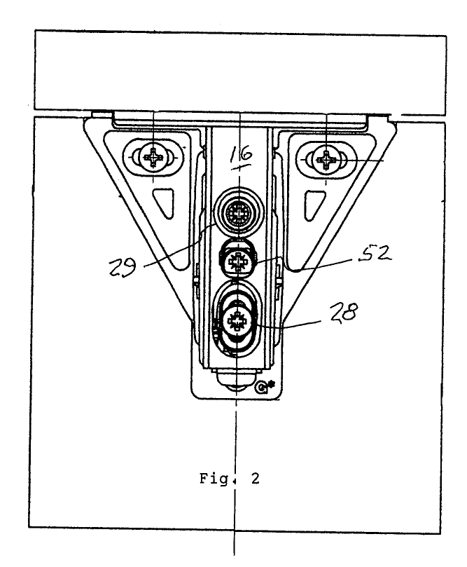

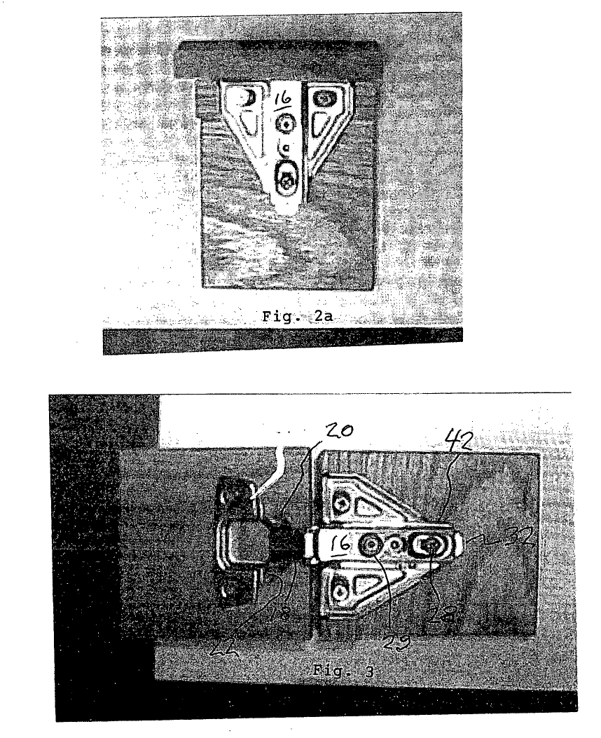

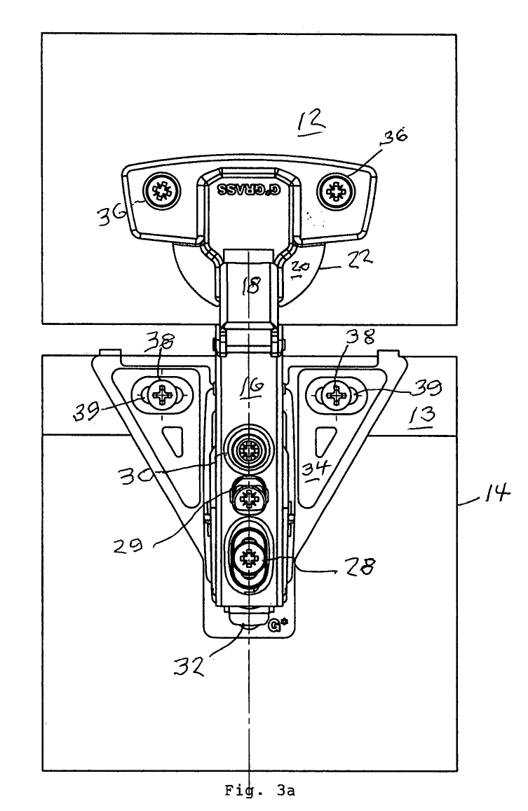

Referring now to the drawings and particularly to FIG. 1, the face frame snap-on hinge of the present invention is shown generally as 10 and functions to support a movable door 12 associated with a frame 14. Hinge 10 includes a hinge arm 16 having a first movable end 18. A hinge cup 20 is frictionally positioned within bore 22 formed in the interior surface of door 12 as best shown in FIG. 3. A hinge arm pin 24 pivotally connects first hinge arm 18 and bore 22 (FIG. 3).

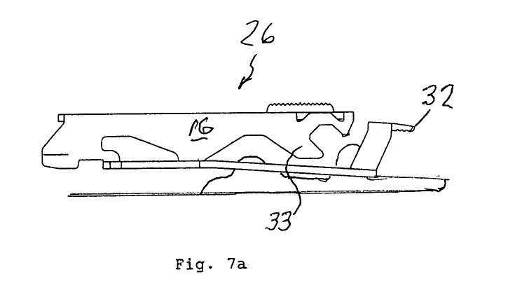

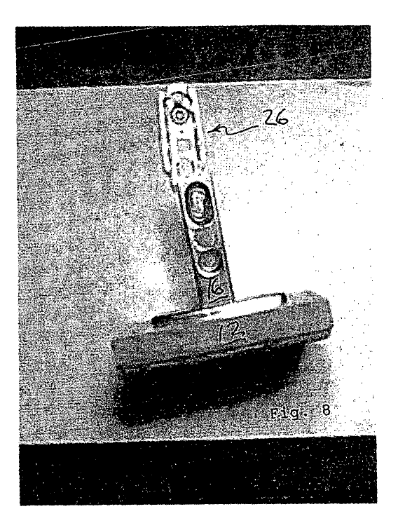

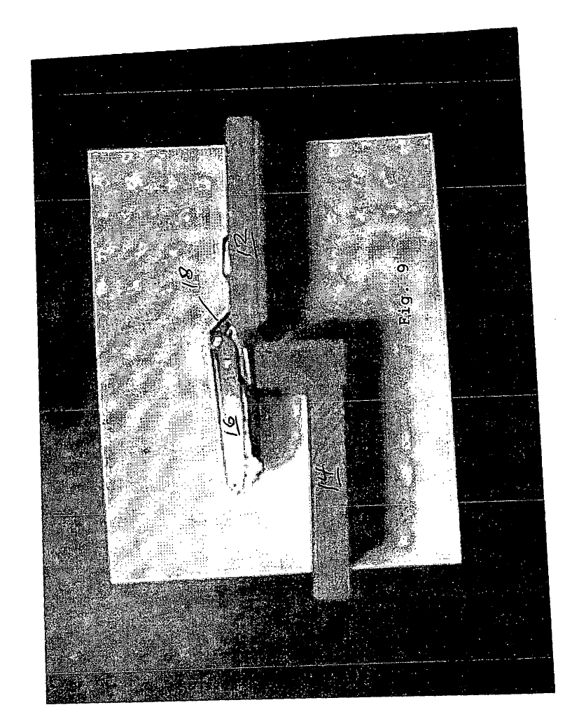

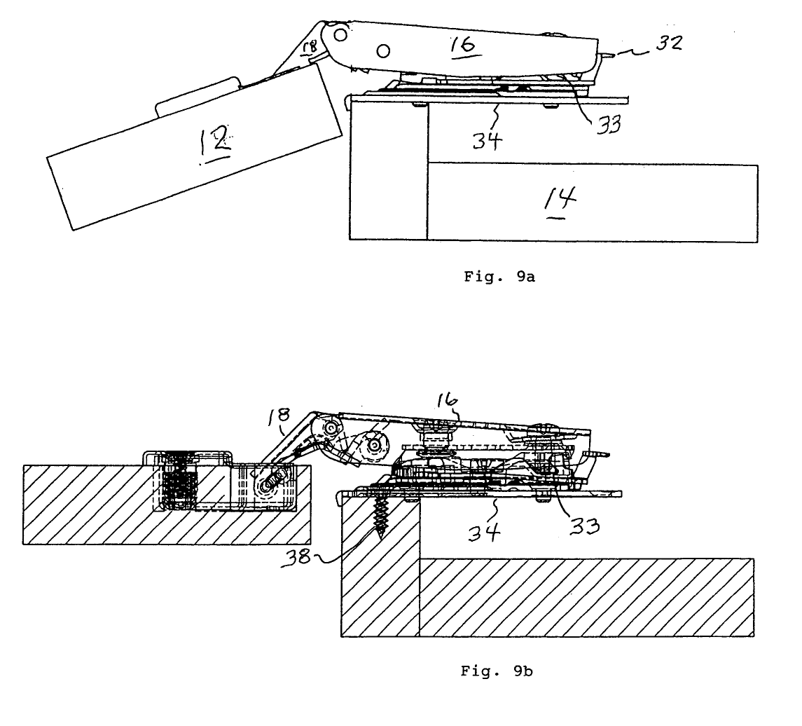

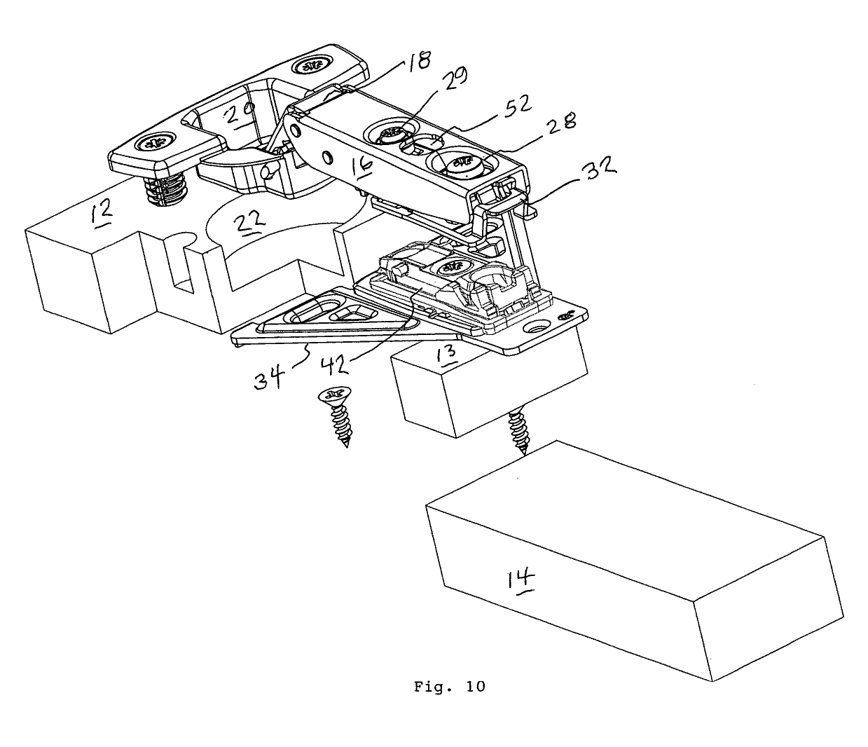

The second end of base plate 16 is cooperatively secured to an adjusting member 42 and a flexible U-shaped member 26 (FIG. 7a), and securement is accomplished by a threaded member 28 assisted by another threaded stop 30 both of which retain U-shaped member 26 in close proximity to hinge arm 16 but permit flexing movement of member 26 by squeezing its extending end 32 upwardly toward hinge arm 16 in a manner subsequently to be described. The combined action of member 26 and hinge 16 form a hinge arm connecting and release means enabling door 12 to be separated from frame 14. When door 12 and frame 14 are separated and unjoined, adjustments can be made with respect to the spacing between door 12 and frame 14 by loosening threaded members 28, 30 and slidably positioning hinge arm 16 and U-shaped member 26 with respect to each other.

Base plate 34 is releasably secured to an interior edge 13 of frame 14 by threaded members 38. Vertical adjustability of base plate 34 affecting the vertical positioning of door 12 with frame 14 can be achieved by the use of elongated slots 39 to receive threaded members 38. Loosening threaded members 38 allows base plate 34 to slide within the length of the slots 39 in a vertical direction.

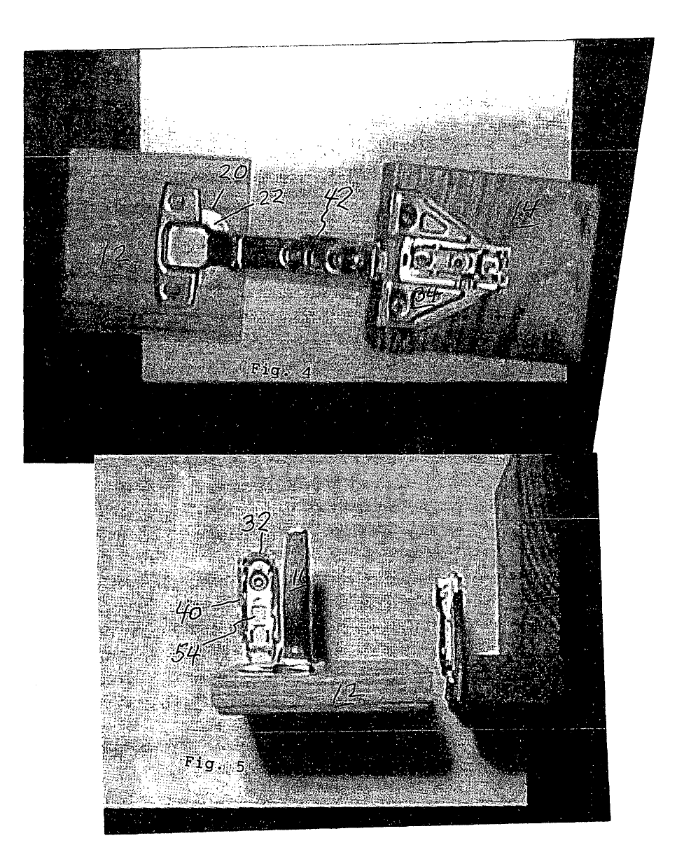

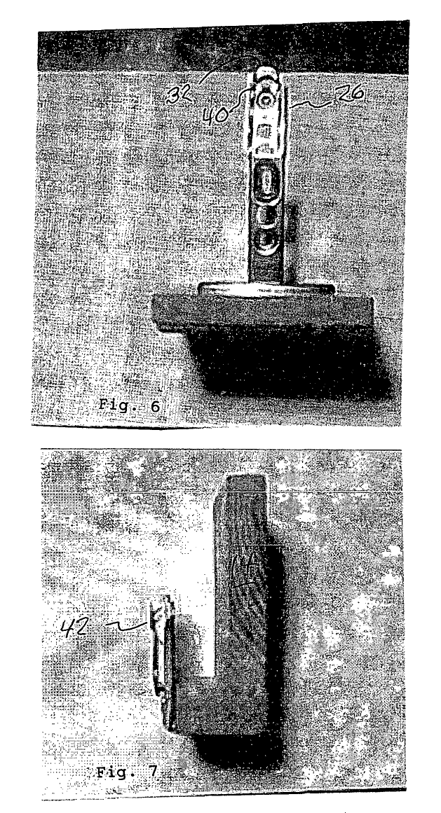

The structure of U-shaped member 26 is best shown in FIGS. 5, 6, 7 and 7a wherein the absence of metal near extending end 32 is readily apparent and depicted as 40 in FIGS. 5 and 6. The absence of metal on either side of the legs 33 of U-shaped member 26 makes extending end 32 very flexible and allows the disengagement of door 12 from frame 14 as previously discussed. When end 32 is squeezed upwardly toward arm 16, the clasping action of legs 33 of U-shaped member 26 against adjusting member 42 is released, and base plate 34 and adjusting member 42 are separated from U-shaped member 26 and hinge arm 16.

Another vertical adjustment of door 12 with respect to frame 14 may be made by turning camming screw 29 extending through member 44 and into base plate accessible through opening 52 in hinge arm 16 and opening 54 in U-shaped member 26. This one hand adjustment with a screwdriver is a simplified feature that in most situations will be preferred over loosening threaded members 36 and manually adjusting elongated slots 38.

From the proceeding description, it can be seen that the snap-on adjustable hinge comprising the present invention and individual components associated therewith have been provided that will meet all of the advantages of prior art devices and offer additional advantages not provided by such devices. With respect to the foregoing description, the optimum dimensional relationship to the parts of the invention including variations in size, materials, shape, form, function, and manner of operation, use and assembly are deemed readily apparent to those skilled in the art, and all equivalent relationships illustrated in the drawings and described in the specification are intended to be encompassed herein.

The foregoing is considered as illustrative only of the principles of the invention. Since numerous modifications and changes will readily occur to those skilled in the art, and it is not desired to limit the invention to the precise description and operation of the embodiments shown. All suitable modification and equivalents that fall within the scope of the appended claims are deemed within the present inventive concept.

What is claimed is:

1. A face frame snap-on hinge for adjustably supporting a door on a supporting frame member, one of the members having a substantially circular bore, the hinge comprising: a frame cup adapted to be inserted into the bore; a hinge pin mounted in the hinge cup; a hinge arm having first and second ends, the first end pivotally secured to the hinge pin; a base plate releasably securable to one of the members; a door adjusting member movably secured to the base plate; and a U-shaped member associated with the door adjusting member and the base plate to selectively position the door adjusting member with the base plate and thereby selectively position the door with respect to the frame member while the hinge arm second end and the base plate remain connected.

2. The hinge as claimed in claim 1 wherein the hinge arm and U-shaped member are independently adjustable to selectively position the frame member with respect to the door.

3. The hinge as claimed in claim 1 wherein the hinge arm and adjusting member are operable to disconnect the hinge arm from the base plate.

4. The hinge as claimed in claim 1 wherein the adjusting member is releasably secured to the hinge arm and U-shaped member.

5. The hinge as claimed in claim 1 wherein the door adjustment member has a camming screw to operably control the selective positioning of the door member with respect to the frame member.

6. The hinge as claimed in claim 2 wherein the hinge arm and U-shaped member are operable to disconnect the hinge arm from the base plate.

7. The hinge as claimed in claim 2 wherein the connecting and release means is releasably secured to the hinge arm and separately and releasably secured to the door adjustment member.

8. The hinge as claimed in claim 1 wherein the base plate is selectively adjustable with the frame.

9. The hinge as claimed in claim 2 wherein the base plate is selectively adjustable with the frame.

10. The hinge as claimed in claim 3 wherein the base plate is selectively adjustable with the frame member.

11. The hinge as claimed in claim 4 wherein the base plate is selectively adjustable with the frame member.

12. The hinge as claimed in claim 11 wherein the hinge arm and the U-shaped member have aligned openings permitting independent adjustment of the door adjusting member therethrough.

13. The hinge as claimed in claim 12 wherein the camming screw is accessible through the aligned openings.

14. The hinge as claimed in 12 wherein the U-shaped member has a pair of clasping legs and the adjusting member has recesses for receiving and releaseably securing the clasping legs to maintain the U-shaped member, adjusting member and hinge arm together.
